(19) United States
(12) Patent Application Publication
(10) Pub. No.: US 2025/0265512 A1
(43) Pub. Date: Aug. 21, 2025

(54) DEVICES, SYSTEMS, AND METHODS FOR AUTOMATED SCHEDULING

(71) Applicant: SCHLUMBERGER TECHNOLOGY CORPORATION, Sugar Land, TX (US)

(72) Inventors: Jan DOLEJSI, Prague (CZ); Derek LONG, Cambridge (GB)

(21) Appl. No.: 19/111,320

(22) PCT Filed: Sep. 27, 2023
(86) PCT No.: PCT/US2023/075221

§ 371 Date: Mar. 13, 2025

Related U.S. Application Data
(60) Provisional application No. 63/378,266, filed on Oct. 4, 2022.

(51) Int. Cl. G06Q 10/0631; E21B 41/00; G06Q 10/0639; G06Q 50/02

(52) U.S. Cl. CPC G06Q 10/0631; E21B 41/00; G06Q 10/06395; G06Q 50/02

(57) ABSTRACT

A rig scheduling system prepares a candidate schedule. The candidate schedule is constrained by a set of constraints. The rig scheduling system identifies a neighborhood for alternative schedules to the candidate schedule. The neighborhood is defined by relationships between constraints within the set of constraints. The rig scheduling system prepares a plurality of alternative schedules within the neighborhood and selects a favorite alternative schedule of the plurality of alternative schedules based on one or more quality metrics.

### CROSS-REFERENCE TO RELATED APPLICATIONS

The subject disclosure claims priority from U.S. Provisional Appl. No. 63/378,266, filed on Oct. 4, 2022, herein incorporated by reference in its entirety.

### BACKGROUND

Automated scheduling defines a framework to describe the physical world associated with a goal-oriented activity. This is achieved through modelling a finite set of actions that can change the state of the world or environment in which an activity is being carried out. The state of the world and changes to the state of the world are detected (e.g., by sensors) and registered. A new plan may be made based on the detected state of the world.

Dynamic automated scheduling generally includes choosing and scheduling a number of actions that will change the state of the world, or an environment in which the activity is being carried out, from an initial state to a goal state. Each action carried out to achieve the goal has an effect on a predetermined number of state variables and can only be executed if a given set of conditions based on another predetermined number of state variables are met.

### SUMMARY

In some aspects, the techniques described herein relate to a method for rig scheduling. A rig scheduling system prepares a candidate schedule, the candidate schedule being constrained by a set of constraints and identifies a neighborhood for alternative schedules to the candidate schedule, the neighborhood being defined by relationships between constraints within the set of constraints. The rig scheduling system prepares a plurality of alternative schedules within the neighborhood and selects a favorite alternative schedule of the plurality of alternative schedules based on one or more quality metrics.

In some aspects, the techniques described herein relate to a method for rig scheduling. A rig scheduling system prepares a candidate schedule, the candidate schedule being based on a first set of constraints and a set of goals. The rig scheduling system identifies a second set of constraints based on the first set of constraints and identifies a neighborhood for alternative schedules to the candidate schedule. The neighborhood is defined by the second set of constraints. The rig scheduling system prepares a plurality of alternative schedules within the neighborhood and selects a favorite alternative schedule of the plurality of alternative schedules based on one or more quality metrics.

This summary is provided to introduce a selection of concepts that are further described below in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 shows one example of a drilling system for drilling an earth formation to form a wellbore, according to at least one embodiment of the present disclosure;

FIG. 2 is a representation of a scheduling system, according to at least one embodiment of the present disclosure;

FIG. 3 is a representation of a rig scheduling system, according to at least one embodiment of the present disclosure;

FIG. 4-1 through FIG. 4-3 are representations of a schedule chart, according to at least one embodiment of the present disclosure;

FIG. 5 is a flowchart of a method for rig scheduling, according to at least one embodiment of the present disclosure; and

FIG. 6 is a flowchart of a method for rig scheduling, according to at least one embodiment of the present disclosure.

### DETAILED DESCRIPTION

This disclosure generally relates to devices, systems, and methods for rig scheduling of multiple wellbores, including identifying a neighborhood for the preparation and selection of alternative schedules based on quality metrics. A system, such as a wellbore system or a basin system including multiple wellbores, may involve the completion of multiple tasks, and multiple units of equipment may perform the tasks. For example, multiple wellbores may be drilled by one or more drill rigs. A scheduler may develop a schedule to drill each well using the available equipment. The scheduler may generate a viable schedule for the wellbore system, but the viable schedule may not be the best schedule, based on quality metrics such as duration, equipment utilization, water usage, carbon impact, and so forth. Such schedulers may evaluate multiple schedules to determine the best schedule, based on the quality metrics. As the wellbore system increases in size, such as by increasing the number of tasks to be completed, the number of possible viable schedules may increase. In some situations, the number of possible viable schedules may increase to unmanageable numbers. Evaluating such schedules may not be possible within a reasonable time frame for a computing system.

A rig scheduler may utilize a local search to determine alternative rig schedules. In a local search, the rig scheduler prepares a candidate solution. The candidate solution is perturbed by making one or more small changes to it. The changed schedules may be called neighbors. The neighbors may be a single perturbation step away from the original candidate. The neighbors are evaluated, and the best is kept. In some situations, a worse candidate may be kept to determine if this path leads to an improved schedule. A path may be a sequence of perturbations perturbed one step at a time.

In some embodiments, the rig scheduler may perturb the candidate by swapping two jobs between two different people, while shuffling the other jobs they have been assigned so that they do not overlap with these newly assigned jobs. That is more likely to give a valid schedule and more likely to give a chance of finding something that improves on the original.

In accordance with at least one embodiment of the present disclosure, a rig scheduler may identify a neighborhood for a local search of alternative schedules. The scheduler may utilize relationships between constraints used in system to identify the neighborhood. This neighborhood may allow the scheduler to quickly and efficiently perturb a schedule to develop meaningful and valuable alternative schedules. The rig scheduler may select a favorite alternative schedule from the alternative schedules. In this manner, the rig scheduler may use a local search to determine the best schedule by constraining the neighbors to within the neighborhood. In some embodiments, the local search may be completed when no neighbors are better than the candidate schedule. In some embodiments, the local search may be completed when the favorite schedule meets a minimum quality metric.

The rig scheduling system provides a number of practical applications that provide benefits and/or solve problems associated with generating rig schedules. For example, by identifying a neighborhood based on relationships between the constraints used to generate the rig schedule, the rig scheduling system can additionally reduce the processing expense over conventional scheduling and/or scheduling systems. For example, the rig scheduling system may identify a neighborhood based on a maximum physical distance a unit of equipment may travel between assignments. This may limit the number of alternative schedules the rig scheduler may analyze in a particular iteration, thereby reducing the processing expense to determine a favorite alternative schedule. This is in contrast with conventional rig schedulers, which may analyze each possible alternative schedule, or which may analyze alternative schedules until they reach the first alternative schedule that is better based on the quality metrics.

By identifying a neighborhood based on relationships between the constraints used to generate the rig schedule, the rig scheduling system can further improve the accuracy and/or quality of the operational wellbore schedule. For example, using the example of a neighborhood identified based on a maximum physical distance a unit of equipment may travel between assignments, the rig scheduler may prepare a rig schedule that limits travel time of equipment between wellbores. This may improve the utilization of the equipment. This is in contrast to conventional systems, which may never arrive at the limited travel-time rig schedule using undirected selection of alternative rig schedules.

As illustrated in the foregoing discussion, the present disclosure utilizes a variety of terms to describe features and advantages of embodiments of the graph generation system described herein. Additional detail will now be provided regarding the meaning of some of these terms. For example, as used herein, a “rig schedule” refers to a schedule of wellbore operations. The rig schedule may include a schedule between different tasks and different wellbore locations to be performed by a set of equipment. Each of the tasks may be planned using a planner.

As used herein, a “variable” may be a single entity that may be assigned a value from a set of choices. The set of choices may be the domain of the variable. The variable may be adjustable, or the values of the variable may be adjustable.

As used herein, a “constraint” may be a proposition that determines the values of one or more variables used during the scheduling of a rig schedule, the proposition of which is made true. A constraint may provide one or more limitations to the rig schedule. For example, a constraint may include a causal chain of events (e.g., act A is completed before act B). In some examples, a constraint may include equipment utilization (e.g., a drill rig may only be at one wellbore at a time). In some examples, a constraint may include labor resources (e.g., a work crew may only be at one wellbore at a time). In some examples, a constraint may include work duration (e.g., a particular act may occur over an associated period of time). In some examples, a constraint may include any other variable or limitation used during wellbore operations. The rig schedule may be developed based on a set of constraints.

As used herein, a “neighborhood” may be the search space a rig scheduler may utilize for alternative schedules. For example, the neighborhood may provide one or more boundaries (e.g., the limits of an adjustable variable) for which the rig scheduler may search within for the alternative schedules. In accordance with at least one embodiment of the present disclosure, the neighborhood may be based on the set of constraints used during rig scheduling. For example, the neighborhood may be defined based on relationships between the constraints. Examples of the relationships used to define the neighborhood may include physical distance between tasks (e.g., the distance equipment or personnel may travel between tasks), consumable resource supply chain, reservoir resources (e.g., resources having a total utilization which may be spread across multiple tasks, with each act using a percentage of the total utilization), any other relationship, and combinations thereof.

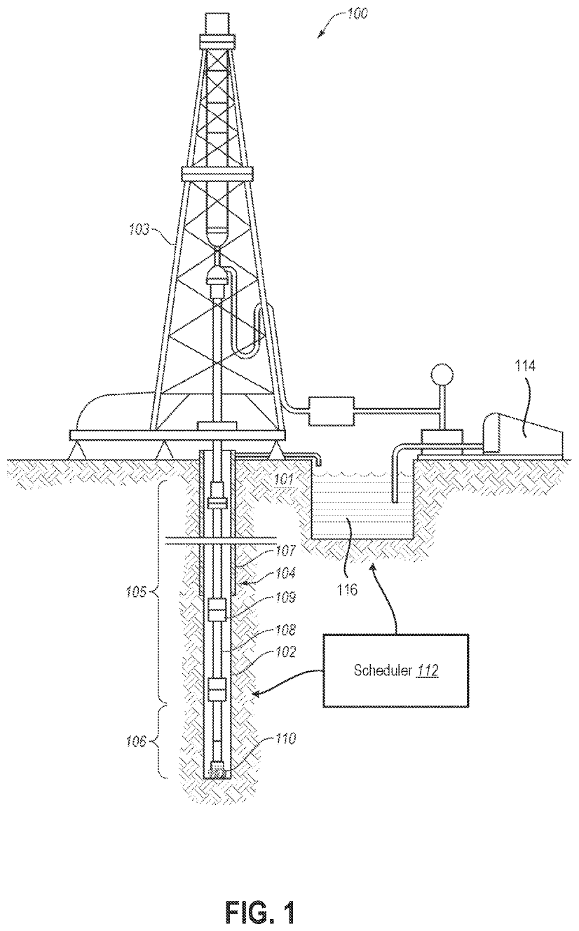

FIG. 1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (RSS). The RSS may include directional drilling tools that change a direction of the bit 110, and thereby the trajectory of the wellbore 102. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

In accordance with at least one embodiment of the present disclosure, the drilling system 100 may include a scheduler 112. The scheduler 112 may perform scheduling activities for the drilling system 100. For example, the scheduler 112 may prepare a schedule for the drilling system 100 to drill the wellbore 102. The schedule may include a series of tasks that the drilling system 100 may perform to drill the wellbore 102. The schedule may be bound by one or more constraints. For example, a constraint to drill the wellbore 102 may include activating pumps 114 to flow drilling fluid 116 through the wellbore 102 while the drill string 105 and the bit 110 is being rotated.

In some embodiments, the scheduler 112 may prepare a candidate schedule to drill the wellbore 102. The candidate schedule may be an initial schedule and series of tasks to drill the wellbore 102. In some embodiments, the candidate schedule may not meet a minimum set of quality metrics. For example, the candidate schedule may have a long duration, have an increased cost, cause excessive equipment wear and tear, not meet any other minimum set of quality metrics, and combinations thereof.

As will be discussed in further detail herein, the scheduler 112 may prepare alternative schedules. The scheduler 112 may compare the alternative schedules to the candidate schedule. Based on the quality metrics, the scheduler 112 may select a favorite schedule. For example, the scheduler 112 may select a favorite schedule based on a plan that improves one or more of the quality metrics, such as improved duration, decreased cost, reduced equipment wear and tear, or any other quality metrics.

In some embodiments, the scheduler 112 may prepare alternative schedules within a neighborhood of alternative schedules. This may improve the quality of the alternative schedules that the scheduler 112 reviews. As discussed herein, the neighborhood of alternative schedules may be based on a relationship between constraints. For example, the neighborhood of alternative schedules may be based on a maximum increase in drilling parameters, such as a maximum change (e.g., increase or decrease) in drilling fluid flow rate. The scheduler 112 may not consider any alternative schedules that exceed the maximum change in drilling fluid flow rate. In this manner, the scheduler 112 may not consider alternative schedules that may not be desirable because of wear and tear based on high fluid flow rates or reduced cuttings transport based on low fluid flow rates. This may help the scheduler 112 to prepare more accurate plans using fewer processing resources by considering fewer alternative schedules.

While the embodiment of FIG. 1 illustrates a single wellbore 102, it should be understood that the scheduler 112 may prepare a plan that is inclusive of multiple wellbores. For example, the scheduler 112 may prepare a plan that utilizes the drill rig 103 to drill the wellbore 102 shown. After the drill rig 103 drills the wellbore 102, the plan may include moving the drill rig 103 to a different location to drill a different wellbore. For instance, as discussed herein, the neighborhood of alternative schedules may include relationships such as the physical distance between the two wellbores and the availability of reservoir resources to drill the second wellbore.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to surface, or may be allowed to fall downhole.

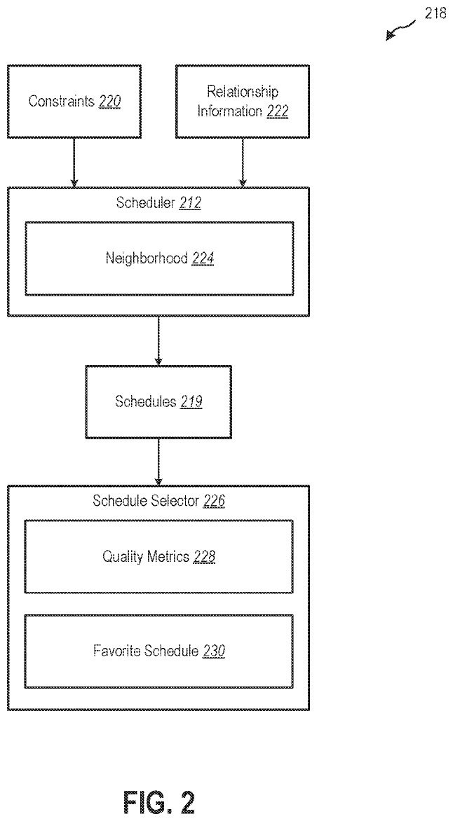

FIG. 2 is a representation of a scheduling system 218, according to at least one embodiment of the present disclosure. The scheduling system 218 includes a scheduler 212 that develops plans. For example, the scheduler 212 may develop plans for drilling operations. The plans may include plans to drill a single wellbore, plans to drill multiple wellbores, plans to plug and abandon wellbores, plans to drill doglegs for wellbores, plans to perform fracking operations, plans to control or monitor wellbore production, any other type of drilling operation plans, and combinations thereof.

The scheduler 212 may perform scheduling operations. Scheduling may involve the orchestration of activity for the future. The activities of the plan may be expected and intended to achieve one or more goals. In some embodiments, a plan may be directed to reach a particular goal state, such as a wellbore depth. A plan may coordinate activities to achieve an overall goal or set of goals. For example, the set of goals may include a particular end state of a drilling system, such as wellbore drilled, plug and abandon, or any other set of goals. Scheduling may involve decisions including how a goal may be achieved, including determining what actions are appropriate and how they are enabled by other actions. Scheduling may further involve decisions regarding when actions should be executed, but relative to each other and in time. Scheduling may also involve determining what resources should be used to support these actions, including consumable resources, non-consumable resources, equipment, labor, and so forth.

In some embodiments, the scheduler 212 may perform scheduling operations. Scheduling operations may involve determining what actions may be performed to achieve a particular goal, including determining or following chains of causality. Causality may be related to different actions. For example, a chain of causality may include not performing action B until action A is completed. In some embodiments, scheduling causality may involve not performing action C until a particular set of conditions are reached (e.g., a drilling fluid flow, a rotational rate of the drill bit, a weight on bit applied to the drill bit). Scheduling operations may further involve determining when a particular action may be performed. In some embodiments, a scheduling operation may be specified in terms of actions to be completed, rather than a particular goal state.

In some embodiments, the scheduler 212 may include a plurality of tasks to accomplish. These tasks may be prepared using variables, such as equipment type, resource type, resource source, job type, job location, and so forth. In some embodiments, the number of possible plans may be based on the number of tasks considered by the scheduler 212 and/or the number of variables adjustable by the scheduler 212. Drilling operations planned by the scheduler 212 may be complex, and may involve multiple adjustable variables. In some embodiments, the number of adjustable variables may be in a range having an upper value, a lower value, or upper and lower values including any of 5, 6, 7, 8, 9, 10, 12, 14, 16, 18, 20, 25, 50, 75, 100, or any value therebetween. For example, the number of adjustable variables may be greater than 5. In another example, the number of adjustable variables may be less than 100. In yet other examples, the number of adjustable variables may be any value in a range between 5 and 100. In some embodiments, it may be critical that the number of adjustable variables is greater than 10 to prepare accurate and representative plans for the drilling system. In some embodiments, the candidate schedule may be prepared with greater than 10 adjustment variables, greater than 14 adjustment variables, greater than 16 adjustment variables, greater than 18 adjustment variables, greater than 20 adjustment variables, greater than 25 adjustment variables, greater than 50 adjustment variables, greater than 75 adjustment variables, or greater than 100 adjustment variables.

In some embodiments, the scheduler 212 may perform both scheduling and scheduling operations. In some embodiments, scheduling operations may be a subset of scheduling operations. For example, the scheduler 212 may include a scheduler that selects a subset of wells to drill that achieve a certain production target output at minimum cost. The scheduled solution to this subset may be provided to the scheduler 212 and added to the overall schedule. In this manner, the scheduler may provide an improved schedule that is applied to the overall schedule, thereby improving the quality of the overall schedule.

To prepare a schedule 219, the scheduler 212 may utilize one or more constraints 220. For example, as discussed in further detail herein, when preparing a schedule 219, the scheduler 212 may utilize one or more constraints 220 such as identifying that units of equipment may not be used in two places at once. In some embodiments, the scheduler 212 may develop an initial candidate schedule 219. The candidate schedule 219 may be a first plan that is not generated to meet any particular quality metrics. The candidate schedule 219 may be developed in any manner. For example, the candidate schedule 219 may be generated using a greedy heuristic or a greedy algorithm. In some examples, the candidate schedule 219 may be generated using a relaxed plan heuristic. Because the candidate schedule 219 is generated to meet any particular quality metrics, the candidate schedule 219 may not be a good schedule, or the candidate schedule 219 may not meet a minimum quality metric threshold. For example, the candidate schedule 219 may not meet a duration threshold, a cost threshold, an emission threshold, a water usage threshold, any other minimum quality metric threshold, and combinations thereof.

The scheduler 212 may further generate alternative schedules 219. To generate an alternative schedule 219, the scheduler 212 may utilize relationship information 222 regarding the one or more constraints 220 to identify a neighborhood 224 for the candidate schedule 219. To prepare the alternative schedule 219, the scheduler 212 may adjust variables related to the generation of the candidate schedule 219. For example, the scheduler 212 may identify that two pieces of equipment at two different wellbore sites may be switched. The scheduler 212 may generate an alternative schedule 219 by switching the two pieces of equipment. Other variables may be switched, such as drilling parameters, number of employees on site, any other drilling variable, and combinations thereof.

The neighborhood 224 may identify the outer bounds of the variable adjustment. For example, the neighborhood 224 may be defined by the relationship information 222. The relationship information 222 may include information such as equipment location, equipment availability, equipment maintenance schedules, maximum geographical distance between wellbores, minimum and/or maximum drilling parameters, reservoir resource information, labor availability, labor location, any other relationship information 222, and combinations thereof.

The scheduler 212 may generate a plurality of alternative schedules 219. In some embodiments, the scheduler 212 may generate all of the available candidate schedules 219 in the neighborhood 224 based on the relationship information 222. This may allow a schedule selector 226 to analyze each of the alternative schedules 219 with respect to one or more quality metrics 228. The schedule selector 226 may select a favorite schedule 230 from the alternative schedules 219 based on the one or more quality metrics 228. For example, the schedule selector 226 may select the favorite schedule 230 based on which of the alternative schedules 219 result in the best quality metrics 228.

In some embodiments, the scheduling system 218 may provide the favorite schedule 230 to a drilling operator, and the drilling operator may implement the favorite schedule 230. In some embodiments, the scheduling system 218 may cause the favorite schedule 230 to be implemented by a drilling system. In some embodiments, the scheduling system 218 may provide the favorite schedule 230 to the drilling operator and/or implement the favorite schedule 230 when the schedule selector 226 has not determined that any of the alternative schedules 219 are improvements based on the one or more quality metrics 228. In this manner, the favorite schedule 230 may be the best schedule for the drilling operations based on the identified one or more constraints 220 and relationship information 222. In some embodiments, the scheduling system 218 may provide the favorite schedule 230 to the drilling operator and/or implement the favorite schedule 230 after a predetermined number of iterations and/or after a predetermined period of processing time. In this manner, the scheduling system 218 may provide schedules to the drilling operator on an as-needed basis, such as in real-time or in near real-time.

In some embodiments, the scheduler 212 may use the favorite schedule 230 as a candidate schedule 219 in a new iteration. For example, after the schedule selector 226 has selected the favorite schedule 230, the scheduler 212 may receive the favorite schedule 230. The scheduler 212 may then designate the favorite schedule 230 as the new candidate schedule 219 and generate a plurality of new alternative schedules 219 based on the previously identified favorite schedule 230 (or the new candidate schedule 219). The new alternative schedules 219 may be based on the neighborhood 224 relative to the previously identified favorite schedule 230 (or the new candidate schedule 219). The schedule selector 226 may review the new alternative schedules 219 based on the one or more quality metrics 228 and select a new favorite schedule 230. This process may be repeated. In some embodiments, this process may be repeated until the schedule selector 226 has not identified a new favorite schedule 230 that is improved based on the one or more quality metrics 228. In some embodiments, this process may be repeated for a predetermined number of iterations and/or a predetermined length of time.

In some embodiments, the neighborhood 224 may be the same for each iteration (e.g., for each candidate schedule 219, including candidate schedules based on selected favorite schedules 230). While the neighborhood 224 may be the same, the details of the alternative schedules 219 that are generated by the scheduler 212 may be different. For example, the neighborhood 224 may be based on the relationship information 222 of a maximum physical distance a unit of equipment may travel between wellbores. But because the details of which equipment is used at each wellbore may change from the candidate schedule 219 to the selected favorite schedule 230, the details of the alternative schedules 219 generated by the scheduler 212 may be different.

In some embodiments, the neighborhood 224 may change between iterations. For example, the relationship information 222 may change between iterations. For example, the neighborhood 224 may be based on a first relationship in the relationship information 222 for a first candidate schedule. This may place the favorite schedule 230 in a desired state. The scheduler 212 may then utilize different relationship information 222 to develop a different neighborhood 224. In this manner, the scheduler 212 may generate a schedule that may be desirable based on multiple elements of relationship information 222.

In some embodiments, the one or more quality metrics 228 may change between iterations. For example, a first favorite schedule 230 may be selected based on a first set of quality metrics 228. When the first favorite schedule 230 is used as the candidate schedule 219, a second favorite schedule 230 may be selected based on a second set of quality metrics 228. In this manner, the scheduler 212 may generate a schedule that may be desirable based on multiple different quality metrics 228.

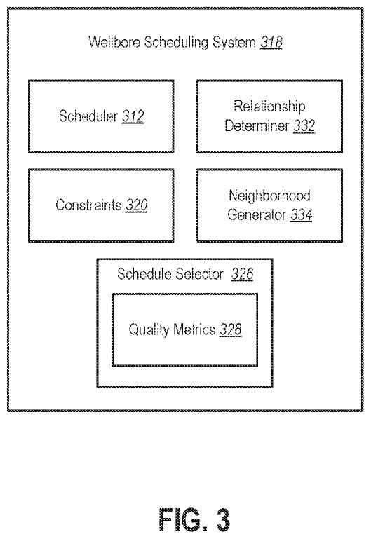

FIG. 3 is a representation of a rig scheduling system 318, according to at least one embodiment of the present disclosure. Each of the components of the rig scheduling system 318 can include software, hardware, or both. For example, the components can include one or more instructions stored on a computer-readable storage medium and executable by processors of one or more computing devices, such as a client device or server device. When executed by the one or more processors, the computer-executable instructions of the rig scheduling system 318 can cause the computing device(s) to perform the methods described herein. Alternatively, the components can include hardware, such as a special-purpose processing device to perform a certain function or group of functions. Alternatively, the components of the rig scheduling system 318 can include a combination of computer-executable instructions and hardware.

Furthermore, the components of the rig scheduling system 318 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The rig scheduling system 318 may include a scheduler 312. The scheduler 312 may review a set of constraints 320 to develop one or more schedules. In some embodiments, the scheduler 312 may develop a schedule using any scheduling mechanism. For example, the scheduler 312 may develop a schedule using a greedy heuristic (e.g., a greedy algorithm). In some examples, the scheduler 312 may develop a schedule using a relaxed plan heuristic. In some examples, as discussed herein, the scheduler 312 may develop a schedule based on an existing schedule (e.g., a candidate schedule or a previously favorited schedule).

The rig scheduling system 318 may further include a relationship determiner 332. The relationship determiner 332 may determine relationships between a set of constraints 320. In some embodiments, the relationship determiner 332 may determine relationships between two different constraints 320 of the set of constraints 320. For example, the relationship determiner 332 may determine relationships between units of equipment and jobsites, such as physical location. In some examples, the relationship determiner 332 may determine a relationship between resources and different jobsites. In some embodiments, the relationship determiner 332 may determine minimum and maximum relationships between the constraints 320. For example, the relationship determiner 332 may determine a maximum physical distance a unit of equipment may travel between different jobs. In some examples, the relationship determiner 332 may determine a maximum number of jobsites at which a reservoir resource may be used.

A neighborhood generator 334 may use the relationships determined by the relationship determiner 332 to identify a neighborhood. The neighborhood may be used to set the boundaries for alternative schedules generated by the scheduler 312. In some embodiments, the neighborhood may be based on a single relationship. In some embodiments, the neighborhood may be based on multiple relationships.

In some embodiments, the relationship determiner 332 reviews a first set of constraints 320 to develop the relationships. Using the relationships based on the first set of constraints 320, the neighborhood generator 334 may generate a second set of constraints 320. The second set of constraints 320 may set the boundaries for the neighborhood. For example, the second set of constraints 320 may identify a proximity to the first set of constraints 320. In some embodiments, the proximity to the first set of constraints 320 may be a difference away from the constraints 320. For example, the proximity to the first set of constraints 320 may include a physical distance, a number of jobsites, a minimum amount of downtime, cost to perform an operation, any other proximity, and combinations thereof.

Using the neighborhood identified by the neighborhood generator 334, the scheduler 312 may generate a plurality of alternative schedules. For example, the scheduler 312 may adjust variables used to generate the scheduler 312 to generate alternative schedules. A schedule selector 326 may review the alternative schedules generated by the scheduler 312. The schedule selector 326 may review the alternative schedules based on one or more quality metrics 328. The schedule selector 326 may select a favorite schedule from the alternative schedules within the neighborhood. The scheduler 312 may then generate a new set of alternative schedules based on the selected favorite schedule.

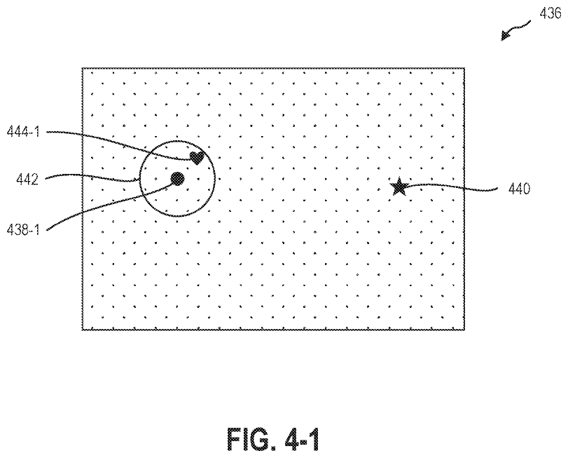

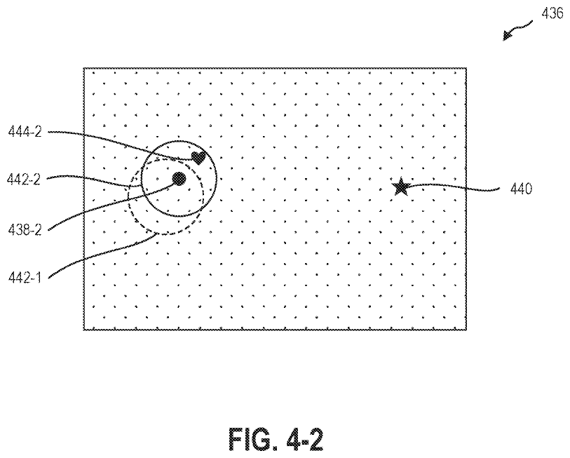

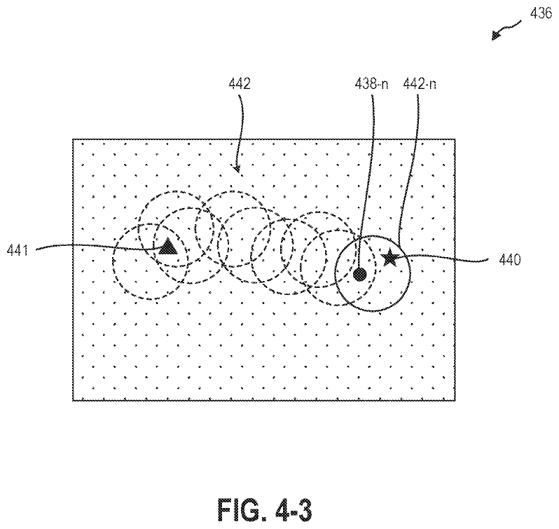

FIG. 4-1 is a representation of a schedule chart 436, according to at least one embodiment of the present disclosure. The schedule chart 436 includes a landscape of possible viable schedules (illustrated as dots within the schedule chart 436) for a given scheduling system. For example, a scheduling system may have a set of goals, resources, and jobsites. A viable schedule may be a schedule that meets the goals using one or more of the units of equipment at the jobsites. But, as will be understood, a viable schedule may not be a good schedule. Put another way, a viable schedule may not meet one or more minimum quality metrics thresholds. For example, a viable schedule may have too long of a duration, have too high of a cost, cause too much wear and tear on equipment, or otherwise not meet the minimum quality metrics threshold.

When developing a schedule for a particular drilling operation, the scheduler may generate a first candidate schedule 438-1. The first candidate schedule 438-1 may be a viable schedule, meaning that the goals may be met using the available resources. But the first candidate schedule 438-1 may not be a good schedule, or may not meet the minimum quality metrics threshold. The schedule chart 436 may include a best schedule 440. The best schedule 440 may be the schedule that is best, based on a particular set of quality metrics. For example, the best schedule 440 may be the schedule that has the highest value of a particular quality metric or set of quality metrics (or the lowest value, based on the particular quality metric or set of quality metrics).

As may be seen, the schedule chart 436 includes a very large number of possible viable schedules. For example, the schedule chart 436 may include thousands, millions, billions, or more possible viable schedules. Manually evaluating each of the possible viable schedules is not practical, or even possible. Indeed, evaluating each of the possible viable schedules with a computing system may not be practical or even possible, as the computing times may be days, weeks, or more.

Conventionally, a scheduling system may attempt to reach the best schedule 440 by adjusting the first candidate schedule 438-1 until the adjusted candidate schedule is better based on the quality metrics. This may allow the scheduling system to identify better schedules. However, to make the calculations and review of alternative schedules feasible, if the scheduling system is not identifying a schedule that is better based on the quality metrics within an allotted time or number of iterations, the scheduling system may stop and identify the candidate schedule as the best. This may result in a local best schedule 441 (as may be seen in FIG. 4-3) that is locally the best (e.g., the best schedule reviewed), but may not be the global best schedule 440.

In accordance with at least one embodiment of the present disclosure, the schedule chart 436 may evaluate a smaller number of alternative schedules, as outlined by a neighborhood 442. As discussed herein, the neighborhood 442 may be based on relationships between constraints used to generate the first candidate schedule 438-1. The neighborhood 442 may limit the number of alternative schedules considered by the scheduling system.

The scheduling system may select a first favorite schedule 444-1. The first favorite schedule 444-1 may be located within the neighborhood 442. The first favorite schedule 444-1 may be the best schedule within the boundaries of the neighborhood 442. For example, the first favorite schedule 444-1 may be the alternative schedule within the boundaries of the neighborhood 442 that has the highest value of a particular quality metric or set of quality metrics (or the lowest value, based on the particular quality metric or set of quality metrics).

When the scheduling system has selected the first favorite schedule 444-1, the scheduling system may identify the first selected favorite schedule 444-2 as the new candidate schedule. For example, as may be seen in FIG. 4-2, the second candidate schedule 438-1 is the same schedule as the first selected favorite schedule 444-1. The first neighborhood 442-1 for the first candidate schedule 438-1 is shown in dotted line. A second neighborhood 442-2 may be generated around the second candidate schedule 438-2. The scheduling system may identify a second favorite schedule 444-2.

As may be seen in FIG. 4-3, the scheduling system may iterate through a series of favorite schedules. This is illustrated by the series of neighborhoods 442 shown in dashed lines. The scheduling system may climb through these different favorite schedules until the scheduling system reaches a final candidate schedule 438-n having a final neighborhood 442-n. The best plan 440 may be located within the final neighborhood 442-n. In this manner, the scheduling system may identify the best schedule 440 within the schedule chart 436.

In accordance with at least one embodiment of the present disclosure, the scheduling system may be able to identify the best schedule 440 while moving past the local best schedule 441. For example, the local best schedule 441 may be the same as the first favorite schedule 444-1 (or the second candidate schedule 438-2). By basing the neighborhoods 442 on relationships between the constraints used to generate the schedules, the scheduling system may focus the analysis of alternative schedules on the factors that may impact the quality metrics of the schedules. In this manner, the scheduling system may not stop at the local best schedule 441, but may identify the overall best schedule 440, or at least a better schedule than the local best schedule 441.

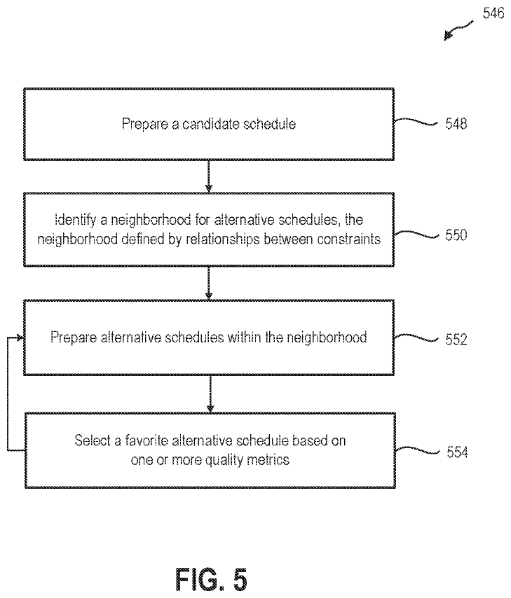

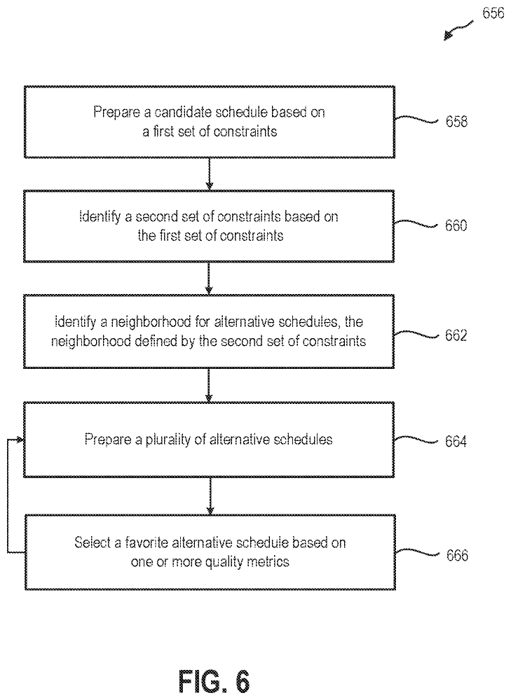

FIGS. 5 and 6, the corresponding text, and the examples provide a number of different methods, systems, devices, and non-transitory computer-readable media of the rig scheduling system. In addition to the foregoing, one or more embodiments can also be described in terms of flowcharts comprising acts for accomplishing a particular result, as shown in FIGS. 5 and 6. FIGS. 5 and 6 may be performed with more or fewer acts. Further, the acts may be performed in differing orders. Additionally, the acts described herein may be repeated or performed in parallel with one another or parallel with different instances of the same or similar acts.

As mentioned, FIG. 5 illustrates a flowchart of a series of acts for a method 546 in accordance with one or more embodiments. While FIG. 5 illustrates acts according to one embodiment, alternative embodiments may omit, add to, reorder, and/or modify any of the acts shown in FIG. 5. The acts of FIG. 5 can be performed as part of a method. Alternatively, a computer-readable medium can comprise instructions that, when executed by one or more processors, cause a computing device to perform the acts of FIG. 5. In some embodiments, a system can perform the acts of FIG. 5.

The rig scheduling system may use a scheduler to prepare a candidate schedule at 548. The candidate schedule may be constrained by a set of constraints. For example, as discussed herein, the scheduler may constrain the schedule based on equipment availability or other constraints. In some embodiments, the candidate schedule may be a viable schedule. Put another way, the candidate schedule may accomplish the goals of a particular drilling operation. But the candidate schedule may not be the best schedule, or the candidate schedule may not have met a certain minimum quality metric threshold. In some embodiments, the scheduler may prepare the candidate schedule using any scheduling mechanism, such as a greedy heuristic or greedy algorithm.

In some embodiments, the rig scheduling system may identify a neighborhood for alternative schedules to the candidate schedule at 550. The rig scheduling system may define the neighborhood by relationships between constraints. For example, the rig scheduling system may define the neighborhood by determining a maximum physical distance a unit of equipment may travel between jobsites. In some examples, the rig scheduling system may define the neighborhood by determining resource availability or supply chains.

The rig scheduling system may prepare a plurality of alternative schedules within the neighborhood at 552. For example, the rig scheduling system may adjust one or more variables of the candidate schedule to prepare an alternative schedule. The neighborhood may define the boundaries or the extent to which the rig scheduling system may adjust the variables to prepare the alternative schedules. In some embodiments, the rig scheduling system may prepare all of the viable available schedules within the neighborhood.

In some embodiments, the rig scheduling system may select a favorite alternative schedule from the prepared alternative schedules at 554. The rig scheduling system may select the favorite alternative schedule based on one or more quality metrics. For example, the rig scheduling system may select the favorite alternative schedule based on which of the alternative schedules shows an improvement (or the most improvement) relative to the quality metrics. For example, the rig scheduling system may select the favorite alternative schedule that has the fastest schedule, the lowest equipment downtime, the lowest cost, the lowest equipment maintenance costs, the lowest labor utilization, any other quality metric, and combinations thereof.

In some embodiments, the rig scheduling system may repeat acts 552 and 554. For example, after the rig scheduling system selects the favorite alternative schedule, the rig scheduling system may prepare new alternative schedules within the neighborhood. The rig scheduling system may select a new favorite alternative schedule from the new alternative schedules. This process may be repeated until the best rig schedule is found. For example, this process may be repeated until none of the alternative schedules are better than the candidate schedule (e.g., the selected favorite schedule) based on the quality metrics.

As a specific example, the plurality of alternative schedules prepared by the rig scheduling system may be a first plurality of alternative schedules and the selected favorite alternative schedule may be a first favorite alternative schedule. The rig scheduling system may prepare a second plurality of alternative schedules within the neighborhood. In some embodiments, the rig scheduling system may select a second favorite alternative schedule from the second plurality of alternative schedules.

In some embodiments, the rig scheduling system may implement the first favorite alternative schedule when none of the second plurality of alternative schedules are better than the first alternative schedules based on the one or more quality metrics. For example, the rig scheduling system may transmit the first favorite alternative schedule to a drilling operator and/or an automated drilling system. The drilling operator and/or the automated drilling system may review and implement the acts of the first favorite alternative schedule.

In some embodiments, the neighborhood may be a first neighborhood and the relationships between the constraints are first relationships between constraints. In some embodiments, the rig scheduling system may identify a second neighborhood based on second relationships between constraints within the set of constraints. In some embodiments, the rig scheduling system may prepare the second plurality of alternative schedules within or based on the second neighborhood.

As mentioned, FIG. 6 illustrates a flowchart of a series of acts for a method 656 in accordance with one or more embodiments. While FIG. 6 illustrates acts according to one embodiment, alternative embodiments may omit, add to, reorder, and/or modify any of the acts shown in FIG. 6. The acts of FIG. 6 can be performed as part of a method. Alternatively, a computer-readable medium can comprise instructions that, when executed by one or more processors, cause a computing device to perform the acts of FIG. 6. In some embodiments, a system can perform the acts of FIG. 6.

The rig scheduling system may use a scheduler to prepare a candidate schedule at 658. The candidate schedule may be based on a first set of constraints and a first set of goals. For example, as discussed herein, the scheduler may constrain the plan based on equipment availability or other constraints.

In some embodiments, the scheduler may prepare the candidate schedule based on a set of goals. For example, the set of goals may include operational goals, such as to drill a particular wellbore to a particular depth, to drill a set of wellbores, to plug and abandon wellbores, reach certain production targets, perform any other drilling operation, and combinations thereof.

In some embodiments, the candidate schedule may be a viable schedule. Put another way, the candidate schedule may accomplish the goals of a particular drilling operation. But the candidate schedule may not be the best schedule, or the candidate schedule may not have met a certain minimum quality metric threshold. In some embodiments, the scheduler may prepare the candidate schedule using any scheduling mechanism, such as a greedy heuristic or greedy algorithm.

In some embodiments, the rig scheduling system may identify a second set of constraints based on the first set of constraints at 660. The second set of constraints may be based on relationships within the first set of constraints. In some embodiments, identifying the second set of constraints may include identifying a proximity to the first set of constraints. For example, identifying the proximity to the first set of constraints may include identifying how much an alternative schedule may deviate from a candidate schedule. The proximity may be based on a particular constraint. For example, the proximity may be a maximum travel distance between jobsites for a unit of equipment. In some examples, the proximity may be a maximum or minimum drilling parameter. In some examples, the proximity may be a maximum or minimum utilization of a resource, such as a consumable or reservoir resource.

As an example, the first set of constraints may include a geographical location of a unit of equipment. Based on the geographical location of the unit of equipment, the rig scheduling system may identify the proximity to the first set of constraints by identifying a maximum travel distance for the unit of equipment. This may allow the rig scheduling system to prepare alternative schedules that reduce the overall travel distance for each unit of equipment, thereby reducing equipment downtime and/or transportation costs.

In some examples, the first set of constraints may include a wellbore task performed by a reservoir resource at a plurality of wellbores and identifying the proximity to the first set of constraints may include identifying a maximum utilization of the reservoir resource at the plurality of wellbores. For instance, the reservoir resource may include a specialty unit of equipment shared across multiple wellbores. The rig scheduler may set a maximum utilization (or a minimum utilization) of the reservoir resource to allow each of the wellbores to receive the benefit of the specialty unit of equipment.

In some embodiments, the rig scheduling system may identify a neighborhood for alternative schedules to the candidate schedule at 662. The neighborhood may be defined by the second set of constraints. For example, using the second set of constraints, the rig scheduling system may identify the neighborhood for alternative schedules. This may set the outer limits or boundaries on variations to the candidate schedule that the rig scheduling system may make. The rig scheduling system may prepare a plurality of alternative schedules at 664. The rig scheduling system may select a favorite alternative schedule based on one or more quality metrics at 666. As discussed herein, in some embodiments, the rig scheduling system may prepare a new plurality of alternative schedules and select a new favorite alternative schedule.

In some embodiments, selecting the favorite alternative schedule may include comparing each alternative schedule of the plurality of alternative schedules to the candidate schedule. The rig scheduling system may select the favorite alternative schedule of the plurality of alternative schedules based on a maximum improvement in the one or more quality metrics. For example, a subset of alternative schedules having more than one alternative schedule may show improvement in the one or more quality metrics over the candidate schedule. The rig scheduling system may compare each of these alternative schedules in the subset of alternative schedules for relative improvement in the one or more quality metrics and select the favorite alternative schedule based on which alternative schedule shows the maximum improvement.

In some embodiments, the methods of the present disclosure may be executed by a computing system. For instance, a computing system may include a computer or computer system that is an individual computer system or an arrangement of distributed computer systems. The computer system can include one or more analysis modules that are configured to perform various tasks according to some embodiments, such as one or more methods disclosed herein. Example modules or computing systems may be in the form of special-purpose downhole tools (e.g., sensor packages), or surface equipment. To perform these various tasks, the analysis module executes independently, or in coordination with, one or more processors, which are connected to one or more computer-readable media. The processors are optionally connected to a network interface to allow the computer system to communicate over a data network with one or more additional computer systems and/or cloud computing systems that may or may not share the same architecture, and may be located in different physical locations. For instance, one computer system may be located in downhole equipment, an alternative or additional computer system may be on a rig or wellbore surface, another may be in a maintenance/repair/mixing facility, another may be in a cloud-computing facility or data center, and may be located in varying countries on different continents.

A processor may include a microprocessor, microcontroller, processor module or subsystem, programmable integrated circuit, programmable gate array, or another control or computing device. Additionally, while computer-readable media may be within a computer system, in some embodiments, computer-readable media may be distributed within and/or across multiple internal and/or external enclosures of a computing system and/or additional computing systems. The computer-readable media may be implemented as one or more computer-readable or machine-readable storage media, transmission media, or a combination of storage and transmission media.

As used herein, “storage media”, “computer-readable storage media,” and the like refer to physical media that stores software instructions in the form of computer-readable program code that allows performance of embodiments of the present disclosure. “Transmission media”, “computer-readable transmission media,” and the like refer to non-physical media which carry software instructions in the form of computer-readable program code that allows performance of embodiments of the present disclosure. Thus, by way of example, and not limitation, embodiments of the present disclosure can include at least two distinct and different kinds of computer-readable media, namely storage media and/or transmission media. Combinations of storage media and transmission media should be included within the scope of computer-readable media.

To further illustrate the distinct nature of storage media and transmission media, storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or solid state drives, or other types of storage devices.

Transmission media may conversely include communications networks or other data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can therefore include a communication network and/or data links, carrier waves, wireless signals, and the like, which can be used to carry desired program, code means, or instructions.

Note that the instructions discussed above may be provided on one computer-readable or machine-readable medium, or may be provided on multiple computer-readable or machine-readable media distributed in a large system having possibly plural nodes. Such computer-readable or machine-readable medium or media is (are) considered to be part of an article (or article of manufacture). An article or article of manufacture may refer to any manufactured single component or multiple components. The computer-readable medium or media may be located either in the machine running the machine-readable instructions, or located at a remote site from which machine-readable instructions may be downloaded over a network for execution. Further, where transmission media is used, upon reaching various computing system components, program code in the form of computer-executable instructions or data structures can be transferred automatically or manually from transmission media to storage media (or vice versa). For example, computer-executable instructions or data structures received over a network or data link can be buffered in memory-type storage media (e.g., RAM) within a network interface module (NIC), and then eventually transferred to computer system RAM and/or to less volatile storage media (e.g., a hard drive) at a computer system. Thus, it should be understood that storage media can be included in computer system components that also (or even primarily) utilize transmission media.

It should be appreciated that described computing systems are merely examples of computing systems, and that a computing system may have more or fewer components than described, may combine additional components not described, or may have a different configuration or arrangement of the components. The various components of a computing system may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device, and/or through manual control by a user who may make determinations regarding whether a given event, action, template, model, or set of charts has become sufficiently accurate for the evaluation of the scheduling or borehole condition data under consideration.

The embodiments of the rig scheduling system have been primarily described with reference to wellbore drilling operations; the rig scheduling systems described herein may be used in applications other than the drilling of a wellbore. In other embodiments, rig scheduling systems according to the present disclosure may be used outside a wellbore or other downhole environment used for the exploration or production of natural resources. For instance, rig scheduling systems of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for rig scheduling, comprising:
preparing a candidate schedule, the candidate schedule being constrained by a set of constraints;
identifying a neighborhood for alternative schedules to the candidate schedule, the neighborhood being defined by relationships between constraints within the set of constraints;
preparing a plurality of alternative schedules within the neighborhood; and
selecting a favorite alternative schedule of the plurality of alternative schedules based on one or more quality metrics.

2. The method of claim 1, wherein the plurality of alternative schedules are a first plurality of alternative schedules and the favorite alternative schedule is a first favorite alternative schedule, and further comprising:
preparing a second plurality of alternative schedules within the neighborhood.

3. The method of claim 2, further comprising:
selecting a second favorite alternative schedule from the second plurality of alternative schedules based on the one or more quality metrics.

4. The method of claim 2, further comprising:
implementing the first favorite alternative schedule when the second plurality of alternative schedules are not better than the first favorite alternative schedule based on the one or more quality metrics.

5. The method of claim 2, wherein the neighborhood is a first neighborhood and the relationships between constraints are first relationships between constraints, and further comprising identifying a second neighborhood based on second relationships between constraints within the set of constraints, and wherein preparing the second plurality of alternative schedules includes preparing the second plurality of alternative schedules within the second neighborhood.

6. The method of claim 1, wherein preparing the candidate schedule includes preparing the candidate schedule with a greedy heuristic.

7. The method of claim 1, wherein the set of constraints includes at least one of equipment type or equipment availability.

8. The method of claim 1, wherein the relationships between constraints includes at least one of physical distance or reservoir resources.

9. The method of claim 1, wherein preparing the candidate schedule includes preparing the candidate schedule with greater than 10 adjustable variables.

10. A method for rig scheduling, comprising:
preparing a candidate schedule, the candidate schedule being based on a first set of constraints and a set of goals;
identifying a second set of constraints based on the first set of constraints;
identifying a neighborhood for alternative schedules to the candidate schedule, the neighborhood being defined by the second set of constraints;
preparing a plurality of alternative schedules within the neighborhood; and
selecting a favorite alternative schedule of the plurality of alternative schedules based on one or more quality metrics.

11. The method of claim 10, wherein identifying the second set of constraints includes identifying a proximity to the first set of constraints.

12. The method of claim 11, wherein the first set of constraints includes a location of a unit of equipment, and wherein identifying the proximity includes identifying a maximum travel distance for the unit of equipment.

13. The method of claim 11, wherein the first set of constraints includes a task performed by a reservoir resource at a plurality of wellbores, and wherein identifying the proximity includes identifying a maximum utilization of the reservoir resource.

14. The method of claim 10, wherein selecting the favorite alternative schedule includes:
comparing each alternative schedule of the plurality of alternative schedules to the candidate schedule; and
selecting the favorite alternative schedule of the plurality of alternative schedules based on a maximum improvement in the one or more quality metrics.

15. A rig scheduling system, comprising:
a processor, and
memory including instructions which cause the processor to:
prepare a candidate schedule, the candidate schedule being based on a set of constraints;
identify a neighborhood for alternative schedules to the candidate schedule, the neighborhood being defined by relationships between constraints within the set of constraints;
prepare a plurality of alternative schedules within the neighborhood; and
select a favorite alternative schedule of the plurality of alternative schedules based on one or more quality metrics.

16. The rig scheduling system of claim 15, wherein the plurality of alternative schedules are a first plurality of alternative schedules and the favorite alternative schedule is a first favorite alternative schedule, and wherein the instructions further cause the processor to prepare a second plurality of alternative schedules within the neighborhood.

17. The rig scheduling system of claim 16, wherein the instructions further cause the processor to select a second favorite alternative schedule from the second plurality of alternative schedules based on the one or more quality metrics.

18. The rig scheduling system of claim 16, wherein the instructions further cause the processor to implement the first favorite alternative schedule when none of the second plurality of alternative schedules are better than the first favorite alternative schedule based on the one or more quality metrics.

19. The rig scheduling system of claim 16, wherein the neighborhood is a first neighborhood and the relationships between constraints are first relationships between constraints, and wherein the instructions further cause the processor to identify a second neighborhood based on second relationships between constraints within the set of constraints, and wherein preparing the second plurality of alternative schedules includes preparing the second plurality of alternative schedules within the second neighborhood.

20. The rig scheduling system of claim 15, wherein preparing the candidate schedule includes preparing the candidate schedule with greater than ten adjustable variables.
